(19) United States
(12) Patent Application Publication
(10) Pub. No.: US 2008/0261669 A1
(43) Pub. Date: Oct. 23, 2008

(54) Automatic corn cutter apparatus and method

(76) Inventors: Ronnie Charles Neidigh, Pueblo, CO (US); Dwight Allen Blickensderfer, Pueblo, CO (US); Denis Ralph Beland, Owatonna, MN (US)

Correspondence Address: Bruce H. Johnsonbaugh;Eckhoff & Hoppe, Suite 2800, 101 Montgomery Street, San Francisco, CA, 94104, US

(21) Appl. No.: 12/148,169

(22) Filed: Apr. 17, 2008

Related U.S. Application Data
(60) Provisional application No. 60/925,789, filed on Apr. 23, 2007.

(51) Int. Cl. A01F 11/06

(52) U.S. Cl. 460/48

(57) ABSTRACT

An apparatus and method for automatically cutting kernels off ears of corn with reduced damage to the kernels are provided. A circular array of movable kernel cutting knives rotates around an axis of rotation. Singulated ears of corn are conveyed along the axis of rotation into and through the array of kernel cutting knives. A sensor is provided for sensing the size and shape of each ear of corn prior to the ear being conveyed into the array of cutting knives and a knife controller moves the array of cutting knives relative to the axis of rotation in response to input from the sensor to efficiently cut the kernels off the cob with reduced damage to the kernels. The ears may be presented to the kernel cutting knives either tip end or butt end first. The cutting depth of the knives may be varied to compensate for variations in thickness of the kernels. In one embodiment, the ears may be presented to the kernel cutting knives with their husks attached. In this embodiment, the husks are sliced longitudinally parallel to the axis of rotation and are again sliced transversely simultaneously with cutting the kernels off the ear. A novel singulator is provided wherein a disc rotating around an inclined axis utilizes centrifugal force to separate and transfer ears of corn onto a chain conveyor which transports the singulated ears to the remainder of the machine.

### CROSS-REFERENCE TO RELATED APPLICATION

This application claims the benefit of and priority from U.S. provisional application Ser. No. 60/925,789 filed on Apr. 23, 2007.

### BACKGROUND AND BRIEF SUMMARY OF INVENTION

The present invention pertains generally to systems for automatically removing corn kernels from the cob. More particularly, the present invention provides an automatic corn cutter which cuts the kernels off the cobs in a more efficient manner (i.e. less damage to kernels) than the prior art, significantly increasing the yield of usable whole kernels. As described below, the present invention utilizes in a second embodiment the novel approach of removing the kernels while the husk is still on the ear of corn. The present invention eliminates the need for much of the apparatus otherwise required by the prior art systems, as described below.

The prior art knives used to automatically cut kernels off the cob are typically programmed to “ride an imaginary cob.” In other words, the knives are programmed to cut in a predetermined pattern that often does not conform to the shape of the cob, resulting often in damaged and unusable kernels.

The prior art also typically requires the ears of corn to be aligned “tip end” first before entering the kernel cutting knives. The alignment apparatus of the prior art causes some damage in handling the ears, and reduced yield whenever the ears are incorrectly presented “butt end” first to the cutting knives. Such incorrect alignment causes the loss of approximately 5% of otherwise usable kernels.

The prior art typically removes the husk from each ear of corn before removing the kernels from the cob. The husk removal typically requires vigorous handling of the ears of corn, frequently causing damage to the kernels.

There is clearly a need to increase the efficiency of automatic corn cutting machines. The usable corn kernels lost by prior art corn cutters represents a terrible economic and resource waste in a world of rising food costs and massive food shortages.

The present invention overcomes the above-described problems with the prior art.

The present invention provides, for the first time known to applicants, a system whereby the kernel cutting knives are able to follow the surface of the individual ear of corn presented to the knives. The feature is in sharp contrast to the prior art approach of having the knives “cut an imaginary cob.” The present invention provides a sensing system for detecting the surface configuration of each individual ear of corn about to enter the kernel cutting knives. The knives are programmed in a first embodiment to follow the sensing system signal to track the contour of each ear of husked corn and to cut at a predetermined depth beneath the outer surface of the kernels on said ear of corn. The predetermined depth includes the thickness of the kernels. The thickness of the kernels typically varies over the length of the ear of corn. The kernel thickness also varies in response to variables such as variety of corn, the geographic location where the corn was raised, amount of rainfall and other variables. However, for a given amount of corn to be processed, the equipment operator may simply measure the kernel thickness of a sample ear of corn; that thickness becomes an assigned, fixed depth of cut for the kernel cutting knives.

In another embodiment, the kernel cutting knives may be programmed to cut at various depths below the surface over the length of a single ear. For example, a linear relationship that would cut ⅛ inch deep if the ear is 1 inch in diameter and proportionally deeper until it cuts ¼ inch deep if the ear is 2 inches in diameter (see FIG. 3B and description below). Other mathematical models are possible such as curves, sinusoidal, etc.

Since the knives of the present invention follow the contour of each ear of corn, it is not necessary to align the ears. The present invention allows the ears to be presented to the kernel cutting knives either “tip end” first or “butt end” first. The present invention therefore eliminates the need for alignment equipment required in prior art systems. Such alignment equipment involves sensors and apparatus to realign ears to a proper orientation.

The present invention, as noted above, provides in an alternate embodiment an automatic corn cutter which, for the first time, removes the kernels without first removing the husk! This is accomplished by cutting the kernels off the cob while simultaneously removing the husk from the ear of corn. In the preferred embodiment of the invention, the husk is sliced longitudinally as the ear of corn approaches the kernel cutting blades. As the kernel cutting blades cut and lift the kernels off the cob, the sliced husk is also lifted upwardly and momentarily “blossoms,” i.e., extends away from the cob. Husk chopping blades, preferably positioned adjacent to the kernel cutting blades, cut the husk transversely while the husk is momentarily lifted upwardly and caused to “blossom.”

The present invention significantly increases the yield of automatic corn cutters for the reasons stated above.

A primary object of the present invention is to provide an automatic corn cutter which more efficiently cuts kernels off ears of corn with reduced damage to the kernels, compared with the prior art, and a method of doing same.

A further object of the invention is an automatic corn cutter which automatically senses the size, shape and orientation of ears of corn and automatically moves the cutting knives to follow the contour of each ear of corn presented to the knives.

A further object of the invention is an automatic corn cutter wherein ears can be presented either “tip end” or “butt end” first, thereby eliminating the need for alignment equipment.

A further object is to provide an automatic corn cutter and method capable of removing husks from ears of corn simultaneously with cutting kernels off that same ear of corn.

Other objects and advantages will become apparent from the following description and drawings.

### BRIEF DESCRIPTION OF DRAWINGS

FIG. 1 is a schematic illustration of a typical prior art automatic corn cutter as an ear of corn is about to be fed into the kernel cutting knives;

FIG. 2 is a schematic illustration of the same typical prior art automatic corn cutter shown in FIG. 1 wherein the kernel cutting knives are set to cut at a different angle than the knives illustrated in FIG. 1;

FIG. 3A is a schematic illustration of a first embodiment of the present invention showing an ear of corn being presented to kernel cutting knives;

FIG. 3B is a schematic illustration of a variation of the embodiment shown in FIG. 3A wherein the size of the kernels on the ear of corn varies in proportion to the outer diameter of the exposed kernels of corn;

FIG. 4 is a schematic illustration of the embodiment of the invention shown in FIGS. 3A and 3B but wherein the ear of corn is presented to the kernel cutting knives “butt end” first;

FIG. 5 is a schematic illustration of a second embodiment of the invention wherein an ear of corn with its husk attached is being presented to kernel cutting knives and husk cutting knives wherein the husk is being removed simultaneously with the kernels;

FIG. 6 is a schematic illustration of a third embodiment of the invention wherein the husk is removed simultaneously with the kernels but wherein the husk cutting knives and kernel cutting knives are different from those shown in FIG. 5;

FIG. 7 illustrates a further embodiment of the invention having a different embodiment of husk chopping blades;

FIG. 8 is a sectional view along the line 8-8 of FIG. 7;

FIG. 9 is an illustration of a prior art kernel cutting knife blade showing how the knife blade is rotated inwardly and outwardly relative to longitudinal axis X-X; and

FIG. 10 is a perspective view of a novel singulator utilized in conjunction with the invention.

### DETAILED DESCRIPTION OF THE DRAWINGS

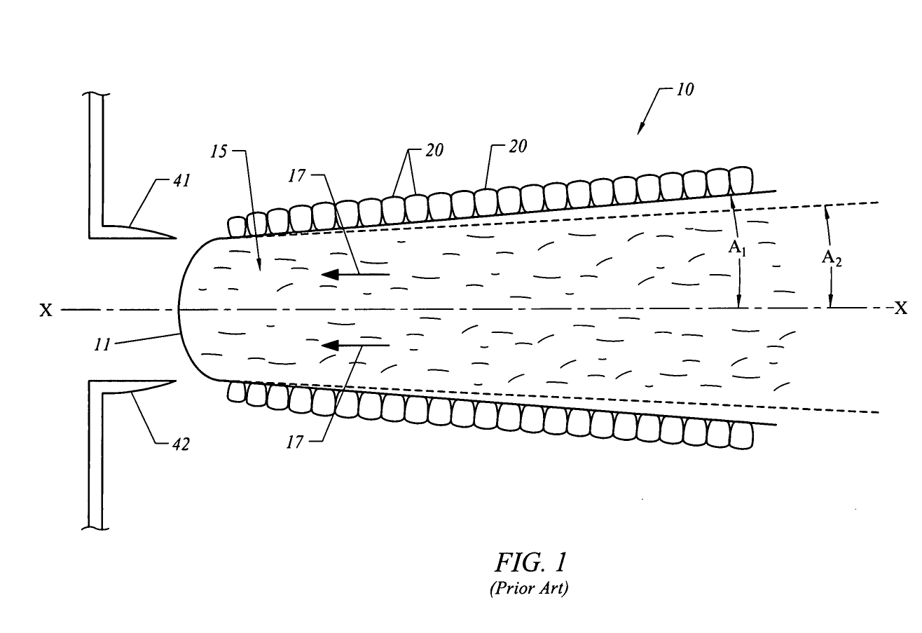

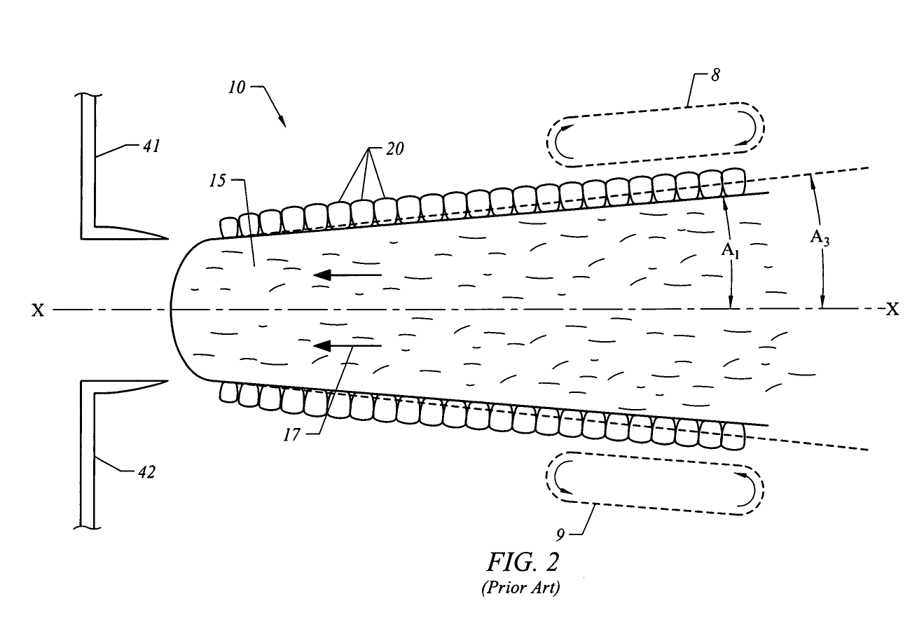

FIGS. 1 and 2 are schematic illustrations of a typical prior art automatic corn cutter having rotating kernel cutting knives 41 and 42. The prior art machines ordinarily have six rotating blades forming an “iris,” much like the iris of a camera. The six knives are movable and mechanically linked in such a way as to permit the diameter of the iris to open and close while maintaining a uniform circle and to keep the knives evenly distributed around the circle. It is the job of the knives to cut the kernels from the cob at the correct depth below the outer surface of the kernels while cutting through or otherwise damaging a minimum of kernels. Only two blades 41 and 42 are illustrated for clarity. An ear of corn 10 is shown with its tip-end 11 presented to knives 41,42 and moving in the direction of arrows 17.

The present invention utilizes prior art techniques for conveying, metering and feeding ears into and through the cutting knives. Those techniques are well known in the art and are not described herein in the interest of brevity, and not shown in the drawings for clarity. Conveyors known in the art convey singulated ears of corn into and through cutting knives 41,42. Such conveyors typically include pairs of rollers on opposite sides of the ears of corn. One such pair of rollers 8 and 9 is shown in FIG. 2. The conveyor rollers are not shown in the rest of the drawings for the sake of clarity. Although prior art singulators may be used together with the present invention, a novel singulator shown and described below is preferably used.

The cob 15 of ear 10 carries kernels 20. The husk has previously been removed and the husk is therefore not shown in FIGS. 1 and 2. As noted above, the prior art blades 41,42 are programmed to “ride an imaginary cob” and, as shown in FIG. 1, the cutting pathway of knives 41,42 is set at an angle A₂. In FIG. 1, the actual cob 15 has a surface which is inclined at an angle A₁ with respect to the longitudinal axis X-X of ear 10 (and cob 15) and of the rotating knives 41,42. Since the angle A₁ indicating the slope of the actual surface of cob 10 is greater than angle A₂, knives 41,42 will cut into the cob and portions of the cob will be intermixed with the severed kernels.

In the case illustrated in FIG. 2, however, the prior art knives 41 and 42 are programmed to ride an imaginary cob having a surface angle of A₃ which, in fact, is larger than the actual surface angle A₁ of the cob 15. In this instance, as the ear 10 is driven into rotating blades 41,42 in the direction of arrows 17 the knives will cut above the surface of the cob and damage most of the kernels 20 on the surface of cob 15.

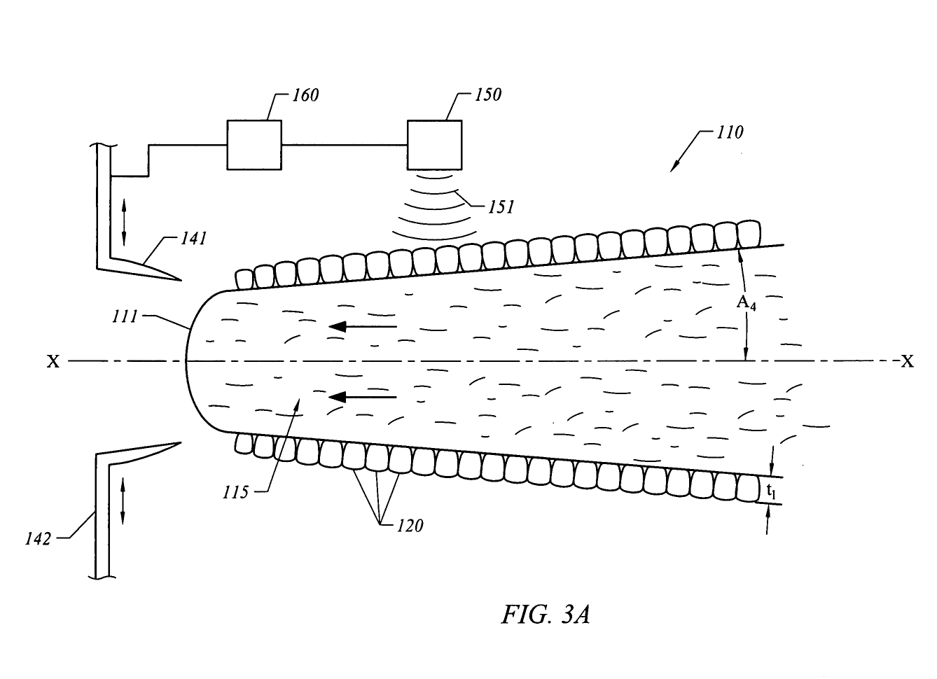

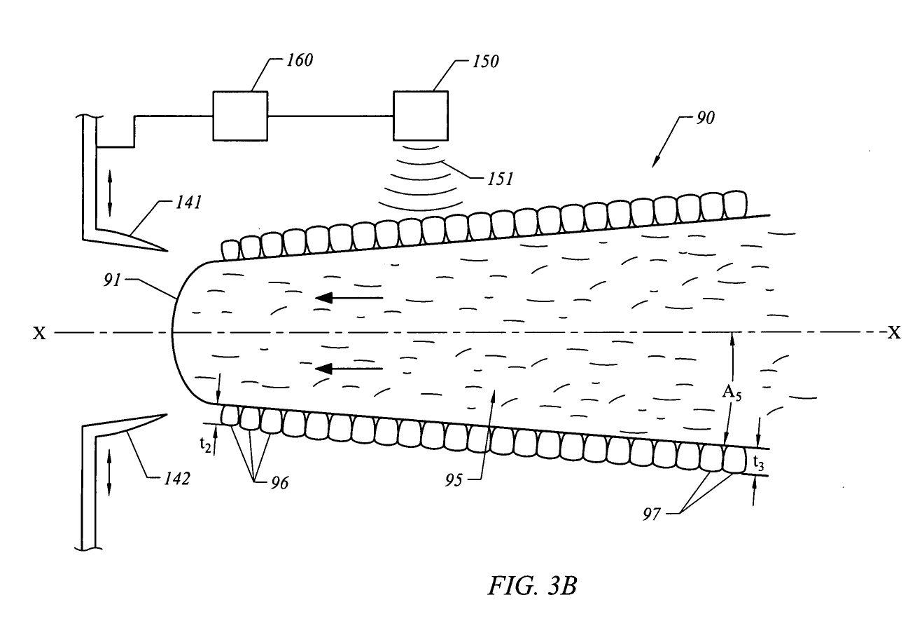

FIG. 3A illustrates a first embodiment of the present invention wherein an ear of corn 110 having cob 115 and kernels 120 is presented to rotating kernel cutting knives 141 and 142 of the present invention. The ear 110 has previously had its husk removed by techniques known in the art.

A sensing means 150 is positioned upstream of kernel cutting blades 141,142 and senses the actual surface contour of the ear 110 (i.e. the outer surface of kernels 120) being presented to knives 141,142. As illustrated in FIG. 3A, the ear 110 has its tip end 111 presented to knives 141 and 142. Sensing means 150 may be either a mechanical sensing device or an optical device, as illustrated in FIG. 3A, which generates a signal 151 directed at the surface of ear 110 and senses the actual contour of the outer surface of kernels 120. In the embodiment shown in FIG. 3, wherein the husk has been previously removed, the “surface” of the ear is the same as the outer “surface” of kernels 120. The information collected by sensing means 150 is transmitted to a controller 160 for knives 141-142. In the example of FIG. 3A, the angle A₄ sensed by sensing unit 150 is the same as the actual slope of the surface of cob 115. This allows the knives of the present invention to follow the actual surface of cob 115 much more closely than the knives of the prior art. As noted above, an assigned thickness t₁ of the row of kernels 120 is entered into the knife control mechanism 160. The thickness t₁ may be assigned arbitrarily or may be assigned by the operator actually measuring a sample ear from a batch about to be processed. Thickness t₁ may be fixed or variable over the length of the ear.

FIG. 3B illustrates a variation of the first embodiment of the invention shown in FIG. 3A. In FIG. 3B, the ear of corn 90 has its “tip end” 91 presented to kernel cutting knives 141,142. However, the ear 90 has considerably smaller kernels 96 near its tip end 91 as compared to the kernels 97 which are on a thicker portion of cob 95. As shown in FIG. 3B, kernels 96 have a thickness t₂ which is approximately ⅛ inch and kernels 97 have a thickness t₃ which is approximately ¼ inch. The present invention allows the operator to manually set the angle A₅ at which the kernel cutting blades expand in order to account for the changing dimension of the kernels over the length of the cob 95. In the instance illustrated in FIG. 3B, the thickness of the kernels varies proportionately with the diameter of the cob 95. The present invention alternately allows the knife control means 160 to be programmed to automatically vary the depth of cut in proportion to the sensed outer diameter of the ear of corn.

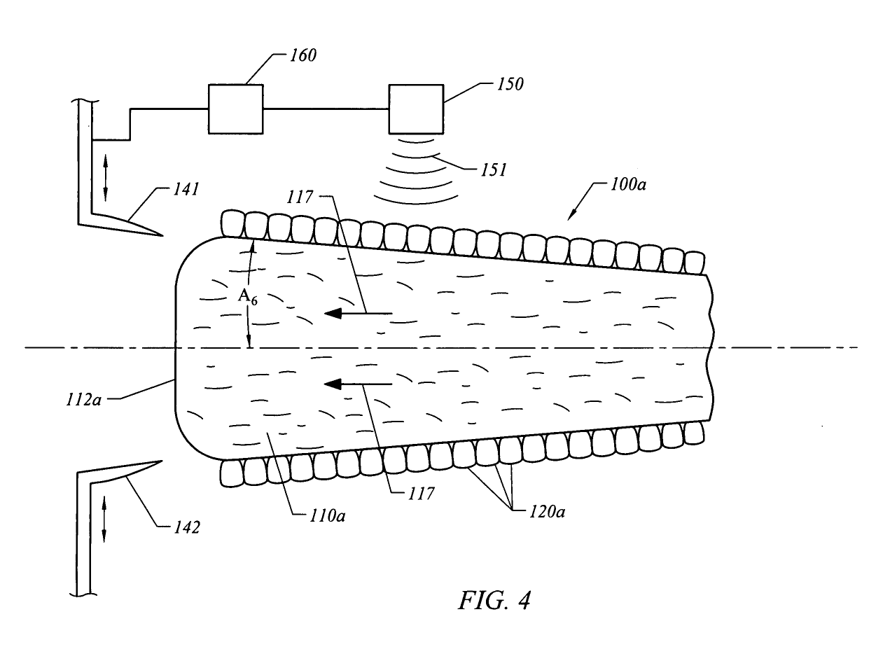

FIG. 4 illustrates the embodiment of the invention shown in FIGS. 3A and 3B but wherein an ear 100a with kernels 120a is presented to the knives 141,142 with its “butt end” 112a entering the knives 141,142 first. In this situation, the surface of the cob 110a as sensed by sensing means 150 is inclined downwardly at an angle A₆. In this case, the knives 141,142 will have to move closer together as the ear 100a passes through the knives in the direction of arrows 117.

As noted above, since the present invention is able to process ears presented either “tip end” first (FIGS. 3A,3B) or “butt end” first (FIG. 4), the alignment apparatus required by prior art machines is eliminated by the present invention. Prior art alignment apparatus is typically quite complex and its elimination is a significant advantage of the present invention. In addition, the present invention avoids the loss of usable kernels caused by prior art alignment apparatus.

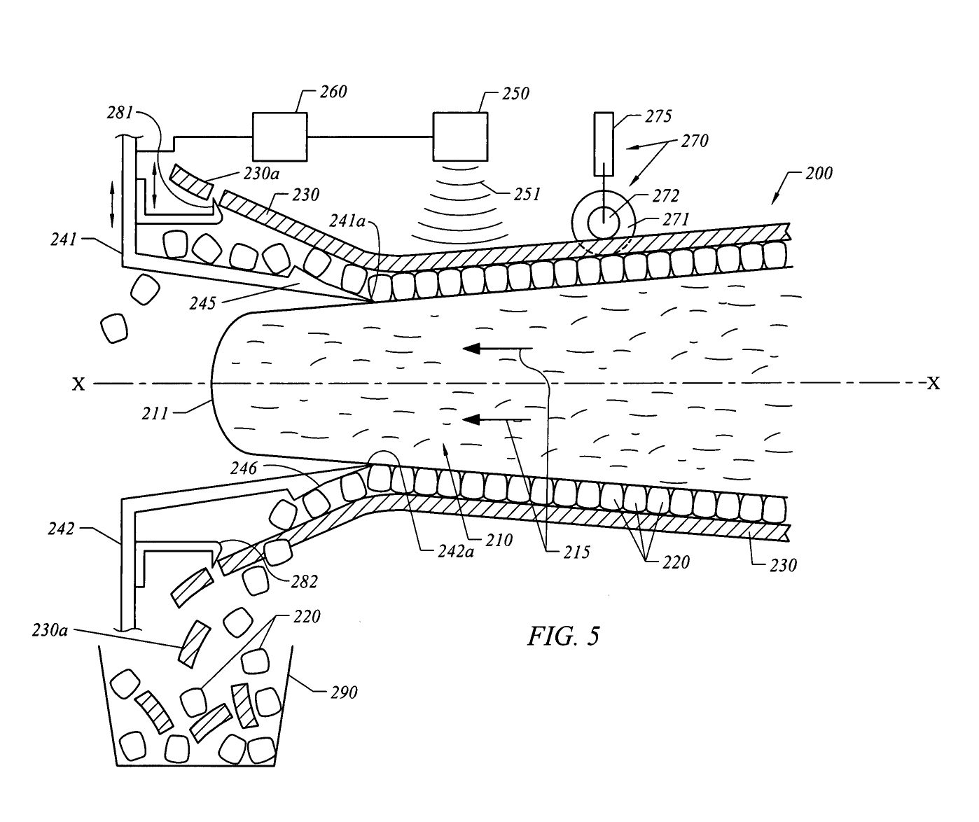

FIGS. 5-8 illustrate embodiments of the present invention in which the husks are removed by the present invention simultaneously as the kernels are cut off the cob. Before discussing this aspect of the invention in detail, we describe the prior art husking techniques briefly.

A common pretreatment technique of the prior art is to pass the ears through a steam tunnel which wilts the husks, making removal easier.

The most common prior art technique of removing husks is by moving the corn over the junction between two rollers which are pressed firmly together. The edges of the husk are captured by this pinching action and the husk is pulled from the corn. While this pinching action is intended to affect only the husk, some, and at times significant damage occurs to the kernels of corn. Any husk which is not removed is a detriment to further processing.

In the prior art “husking” systems, the ears must be conveyed to the husking apparatus, inspected, and some ears returned for further husk removal. Each time the ears are so handled and treated, some loss occurs. These losses are avoided by the embodiments of the present invention wherein the husk is removed simultaneously with the cutting of the kernels off the cob.

FIG. 5 illustrates a further embodiment of the invention wherein an ear of corn 200 is presented with its “tip end” 211 first to the rotating cutting knives 241,242. In this embodiment, the ear of corn has not had the husk removed. Husk 230 remains on the ear of corn 200 as its tip end 211 is presented to knives 241,242. Sensor 250 is shown emitting, for example, an optical output signal 251 to track the outer surface of ear 200 and communicates that information to the controller 260 of blades 241,242. In this embodiment, the sensed size of the ear 200 includes the thickness of husk 230.

An array of preferably three husk slicing knives 270 (only one shown for clarity in FIG. 5) are positioned upstream of blades 241,242 and slice the husk 230 longitudinally or parallel with longitudinal axis X-X as ear 200 moves in the direction of arrows 215 through blades 241,242. Each of the husk slicing blades 270 has a cutting tip 271 that is connected to a roller 272 that follows the surface of the husk. The cutting tip extends, for example, ⅛ inch below the roller to maintain the tip of blade 271 at a proper setting to slice the husk without damaging the kernels 220. Air cylinder 275 is connected to blade 271 and roller 272 to maintain pressure on the blade 271 and roller 272 against husk 230.

Blades 241,242 are somewhat longer in the direction of axis X-X in this embodiment and carry vanes 245 and 246 adjacent the cutting tips 241a and 242a of blades 241,242. The purpose of vanes 245,246 is to momentarily lift the husk 230 and to cause husk 230 to “blossom” outwardly from cob 210. Husk chopping blades 281 and 282, in the embodiment shown in FIG. 5, are carried by kernel cutting blades 241,242, respectively, and blades 281 and 282 extend radially outwardly from longitudinal axis X-X. The use of vanes 245,246 along with “blossoming” of the husk 230 reduces the congestion at the cutting region by causing the kernels and husk to move radially outwardly from axis X-X. The purpose of husk chopping knives 281,282 is to sever the husk 230 transversely into short segments 230a which drop downwardly into a conveyor 290 with the separated kernels. The husk fragments 230a are later separated from the usable kernels 220.

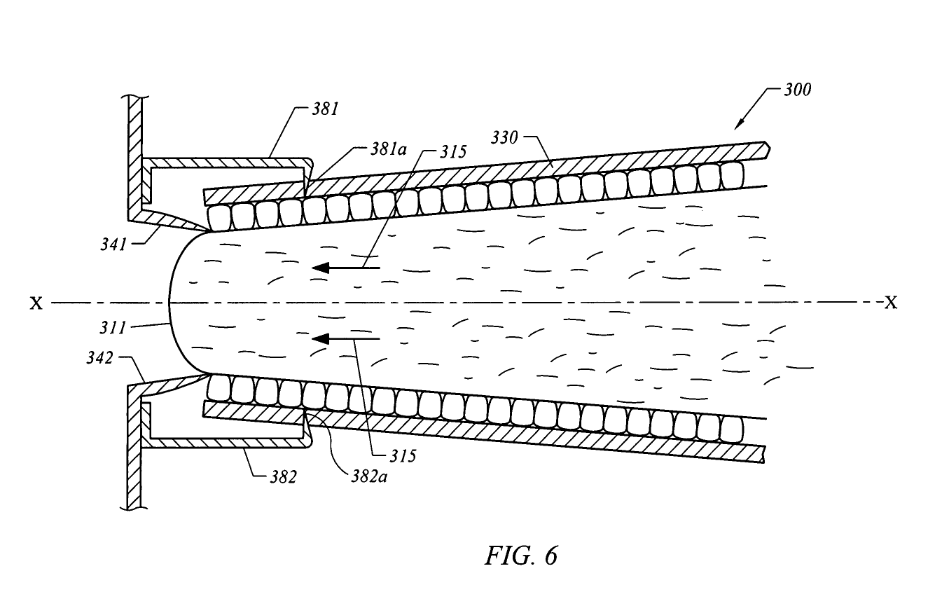

FIG. 6 illustrates an alternative embodiment of husk chopping knives. An ear of corn 300 is presented moving in the direction of arrows 315 with its “tip end” 311 first into the rotating cutting knives 341,342. Husk 330 remains on the ear 300. In FIG. 6, in the interest of clarity, the sensor and controller are not shown. The husk slicing knives are also not shown for the sake of clarity. Husk chopping blades 381 and 382 in this embodiment are carried by kernel cutting blades 341 and 342, respectively. Blades 381 and 382 have inwardly extending (i.e. toward axis X-X) cutting tips 381a and 382a that continuously chop the husk 330 into segments. The cutting tips 381a and 382a contact the husk upstream of the point of contact between kernel cutting blades 341 and 342. The embodiment of FIG. 6 is somewhat less preferred than the embodiment shown in FIG. 5 because of the tendency of portions of husk 330 wrapping around rotating kernel cutting blades 341,342 and rotating husk chopping blades 381,382.

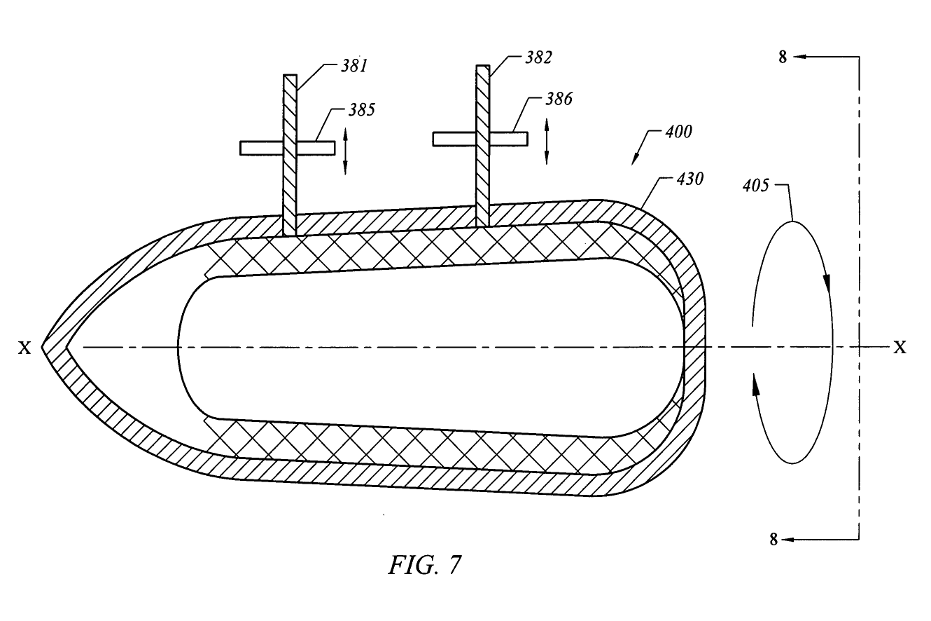

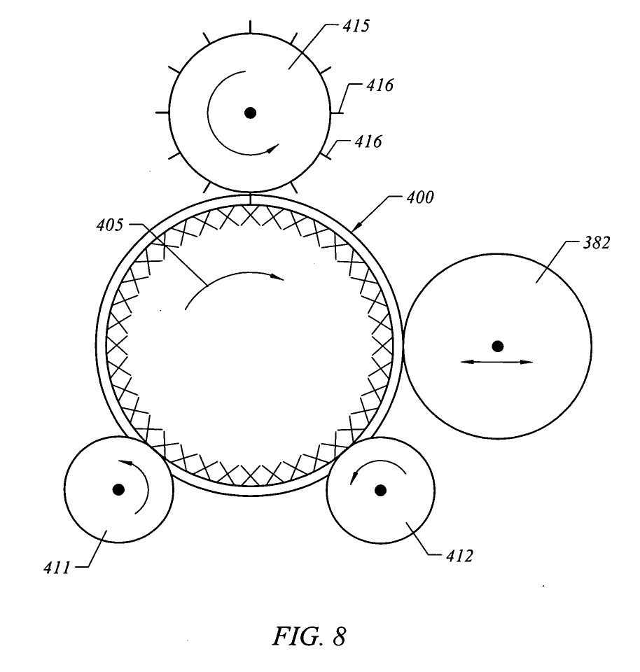

FIGS. 7 and 8 illustrate a further embodiment of husk chopping blades. The embodiment shown in FIGS. 7 and 8 creates transverse cutting of the husk around the circumference of ear 400. Ear 400 must first be brought to rest on a pair of idler rollers 411 and 412 (FIG. 8). A drive roller 415 having a plurality of small spikes 416 around its periphery contacts the outer surface of ear 400 and causes ear 400 to rotate clockwise or in the direction of arrow 405 of FIG. 8. While ear 400 is rotating, a pair of husk chopping saws 381 and 382 mounted on floating axles 385 and 386 cut through the husk 430. The ear of corn 400 will be rotated until the transverse cuts have been made by blades 381 and 382 around the entire periphery of the ear 400. The ear 400 will then be presented to the kernel cutting blades. It is believed that the embodiment shown in FIGS. 7 and 8 is somewhat less preferable than the embodiment shown in FIG. 5 because of the requirement to temporarily halt the motion of ear 400 along longitudinal axis X-X.

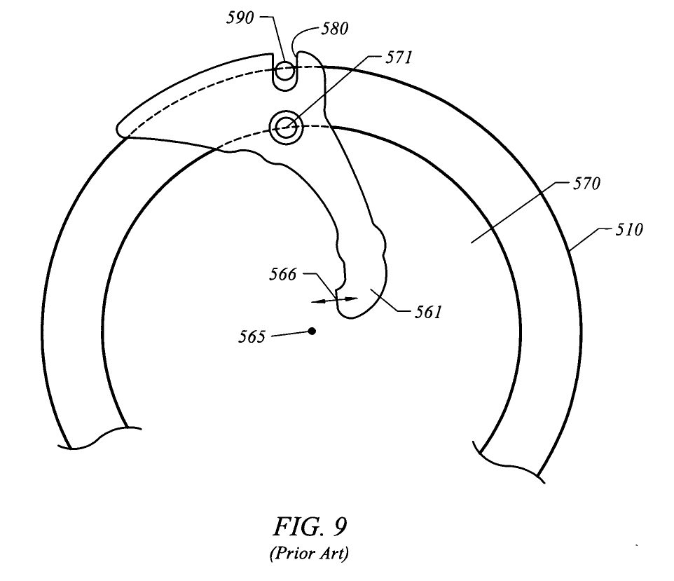

FIG. 9 illustrates a prior art kernel cutting knife blade 561 and how that blade 561 is caused to rotate inwardly or outwardly from the center axis shown as 565 in FIG. 9 (axis 565 is shown as X-X in FIGS. 1-6) and in the direction of arrow 566. The knife 561 is pivotally mounted to main gear 570 at pivot point 571. Blade 561 has a C-shaped opening 580 that interacts with a pin 590 carried by the actuator gear 510.

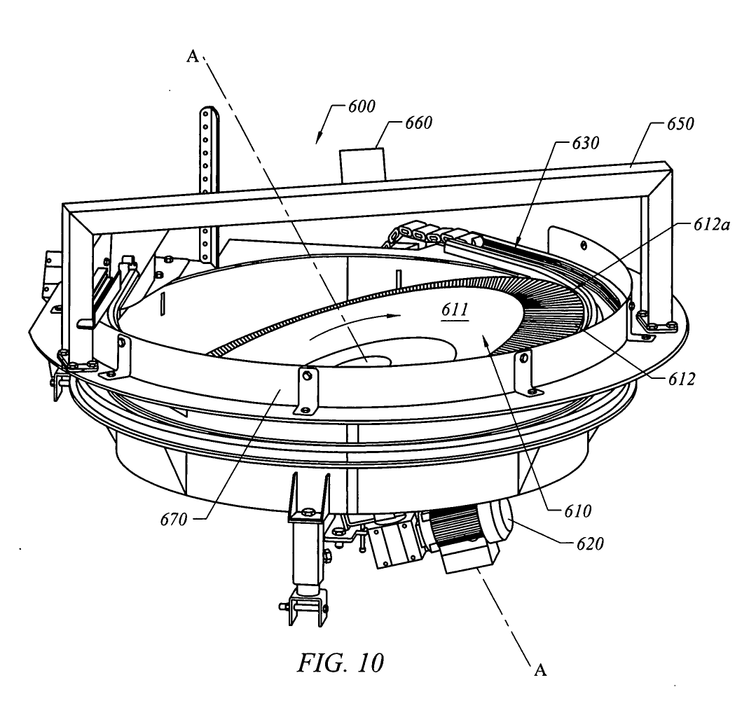

FIG. 10 is a perspective view of a novel singulator shown generally as 600 utilized in the present invention. A rotating, two-part disc 610 rotates around axis A-A which is offset from the vertical and driven at variable speeds by motor 620. Disc 610 includes an inner section 611 which has a relatively smooth surface. The outer peripheral section 612 of disc 610 has a roughened surface adjacent its periphery for traction. Ears (not shown) are deposited onto the center section 611 and moved to the upper peripheral segment 612a of the outer portion 612 due to gravity and centrifugal force. As each ear travels to the upper peripheral segment 612a of the disc, centrifugal force and gravity move the ear radially outwardly, transferring the ear to a chain-type conveyor 630. Only a small portion of the chain 630 is visible in FIG. 10. The chain conveyor 630 conveys the singulated ears around the perimeter of the disc 610 and 2 into the rest of the machine. The relative speed of the chain 630 to the disc 610 can be varied 3 to either move ears closer together during the transfer or further apart. The separation 4 between singulated ears is required later in the machine.

A support 650 supports a sensor 660 for controlling the flow of ears onto the disc 610.

A guide rail 670 prevents ears from falling off the outside of the chain and can be adjusted toward the center of the disc 610 to accommodate varying sizes of ears and to prevent two ears from being side-by-side on the chain conveyor 630.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated. The scope of the invention is to be defined by the following claims.

What is claimed is:

1. Apparatus for automatically cutting kernels off ears of corn, comprising:
a circular array of movable kernel cutting knives, said array rotating around an axis of rotation,
conveyor means for conveying singulated ears of corn along said axis of rotation into and through said array of kernel cutting knives,
sensing means for sensing the size and shape of said ears of corn prior to said ears being conveyed into said array of kernel cutting knives, and
knife control means for moving said array of cutting knives relative to said axis of rotation in response to input from said sensing means to efficiently cut said kernels off said ear of corn with reduced damage to said kernels.

2. The apparatus of claim 1 wherein said ears may be presented to said kernel cutting knives either tip end or butt end first.

3. The apparatus of claim 1 wherein said ears of corn have had their husks removed and wherein said sensing means senses the outer surface of kernels carried by each cob.

4. The apparatus of claim 3 wherein an assigned fixed thickness of kernels is inputted to said knife control means along with input from said sensing means to automatically adjust the position of said kernel cutting knives as each ear passes through said kernel cutting knives.

5. The apparatus of claim 3 wherein a variable thickness of kernels proportional to the outer diameter of said ear is inputted into said knife control means to automatically adjust the position of said kernel cutting knives as each ear passes through said kernel cutting knives.

6. A method for automatically cutting kernels of corn off cobs, wherein a circular array of cutting knives rotates around an axis of rotation and wherein a conveyor moves singulated ears of corn along said axis of rotation into and through said circular array of cutting knives, comprising the steps:
sensing the size and shape of each singulated ear of corn prior to said ear entering said circular array of cutting knives, and
moving said circular array of knives relative to said axis of rotation in response to sensing the size and shape of each singulated ear of corn,
whereby said circular array of cutting knives follows the contour of the cob of each ear to more efficiently cut the kernels off each ear of corn with reduced damage to said kernels.

7. The method of claim 6 wherein said ears of corn have their husks attached, comprising the following steps:
slicing said husks longitudinally parallel to said axis of rotation, and
slicing said husks transversely simultaneously with cutting said kernels off said ear of corn.

8. The method of claim 6 wherein said ears of corn have their husks attached and said conveyor stops each ear before reaching said kernel cutting knives, comprising the following steps:
rotating each ear around said axis of rotation,
slicing said husks transversely as each ear rotates,
conveying said ear toward said cutting knives, and
slicing said husks longitudinally parallel to said axis of rotation.

9. Apparatus for automatically cutting kernels off ears of corn while simultaneously removing the husks from said ears, comprising:
a circular array of kernel cutting knives, said array rotating around an axis of rotation,
conveyor means for conveying singulated ears of corn along said axis of rotation into and through said array of kernel cutting knives,
sensing means for sensing the size and shape of said ears of corn prior to said ears being conveyed into said array of kernel cutting knives,
knife control means for moving said array of cutting knives relative to said axis of rotation in response to input from said sensing means,
first husk cutting means for slicing each husk longitudinally as a singulated ear is conveyed into said array of kernel cutting knives, and
second husk cutting means for transversely cutting each husk as a singulated ear is conveyed into said array of kernel cutting knives.

10. The apparatus of claim 9 wherein each kernel cutting knife has a vane extending radially outwardly from said axis of rotation to lift said husk and to move kernels radially outwardly.

11. The apparatus of claim 10 wherein said second husk cutting means is a plurality of blades wherein each blade extends radially outwardly.

12. The apparatus of claim 11 wherein each said blade is carried by one of said kernel cutting knives.

13. The apparatus of claim 9 wherein said first husk cutting means comprises one or more cutting tips each connected to a roller that follows the surface of said ear of corn, said cutting tip extending below said roller to slice the husk.

14. Apparatus for automatically singulating and separating ears of corn, comprising:
a disc mounted for rotation about an axis inclined relative to a vertical axis, said disc having an upper peripheral segment and having a roughened surface adjacent its outer periphery,
drive means for rotating said disc at variable speeds,
feed means for depositing ears of corn onto said disc,
movable track means positioned adjacent said upper peripheral segment of said disc,
drive means for moving said track means at variable speeds,
movable guide means positioned adjacent said track means and movable relative to said axis of rotation of said inclined disc,
whereby rotation of said disc causes ears of corn to be moved onto said upper peripheral segment and onto said track means by centrifugal force, and whereby adjustment of said guide means toward said axis of rotation of said disc prevents two ears from being transferred side-by-side onto said track means.

15. The apparatus of claim 14 wherein adjustment of the relative speed of said disc and said track means causes a change in the separation of ears transferred onto said track means.
